(19) United States
(12) Patent Application Publication
(10) Pub. No.: US 2006/0146773 A1
(43) Pub. Date: Jul. 6, 2006

(54) Method and system for internet connection of refrigerator

(75) Inventors: Gyu-hwan An, Gwangju City (KR); Tae-hwan Jung, Daegu City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/273,013

(22) Filed: Nov. 15, 2005

(30) Foreign Application Priority Data
Jan. 3, 2005 (KR) 10-2005-0000213

(51) Int. Cl. H04Q 7/24

(52) U.S. Cl. 370/338

(57) ABSTRACT

A method and system for Internet connection of a refrigerator, having a function key for Internet connection, a wireless interface for wireless connection to the Internet according to manipulation by the function key, and a display for displaying a web page by a web browser when the refrigerator is connected to the Internet through the wireless interface unit, are provided. The method includes manipulating the function key for Internet connection and executing the web browser to be displayed on the display unit; allowing the wireless interface unit to be wirelessly connected to an outdoor wireless Internet access point (AP) provided outdoors when the web browser is executed; and allowing the refrigerator to wirelessly connect to the Internet through a wireless Internet server provider associated with the outdoor wireless Internet AP, when the wireless interface unit is connected to the outdoor wireless Internet AP.

### CROSS-REFERENCE TO RELATED APPLICATIONS

This application claims priority from Korean Patent Application No. 10-2005-0000213, filed on Jan. 3, 2005, in the Korean Intellectual Property Office, the disclosure of which is incorporated herein by reference.

### BACKGROUND OF INVENTION

1. Field of Invention

Methods and systems consistent with the present invention relate to connecting a refrigerator to the Internet, and more particularly, to connecting a refrigerator having a communication interface unit to the Internet through a wireless connection.

2. Description of the Related Art

Development of network technology has enabled wired or wireless connection to a network (e.g., the Internet) by use of electric home appliances, such as a refrigerator inside a house, without use of a separate information device, such as a computer. These electric home appliances are often called information electric home appliances. Accordingly, techniques for constructing home networking available for mutual information sharing and data communication by use of the information electric home appliances have gradually been popularized.

Generally, in the case of wired or wireless network connection by means of an electric home appliance, such as a refrigerator, wired or wireless interface units for wired or wireless network connection are installed inside the refrigerator, in addition to a refrigerator driving module to perform the standard function of the refrigerator.

As illustrated in FIG. 4, where a refrigerator 100 having a wired interface unit (not shown), such as a wired local area network (LAN) card, therein is installed inside a house, a web browser within the refrigerator 100 is executed by use of a control key provided in a display unit 101 of the refrigerator 100, to thereby allow the refrigerator 100 to be connected to a network environment outside the house, for example, the Internet 300. At this time, the wired interface unit of the refrigerator 100 is connected to a modem 120 through a connection cable 102 and then to the Internet 300 in a wired manner through an Internet service provider (ISP) 200 outside the house, which is connected to the modem 120 by a separate cable, so that a user can use a desired service.

If a wireless interface unit (not shown), such as a wireless LAN card, is provided in the refrigerator 100, an indoor access point (AP) 110 for wireless connection may be provided between a modem 121 and the refrigerator 100 inside the house. The wireless interface unit of the refrigerator 100 can connect to the Internet 300 by way of the indoor AP 110 and the modem 121, using an Internet connection service provided by the ISP 200 outside the house.

In the case of wired Internet connection by means of a general refrigerator, a separate space inside the house for installing a modem as an additional device for wired network connection, and separate cables between the refrigerator and the modem inside the house, and between the modem and the ISP outside the house, are needed. In the case of wireless Internet connection by means of a general refrigerator, since an indoor AP and a modem as additional devices for wireless network connection must be installed inside the house, a separate space for mounting them, and separate cables between the indoor AP and the modem inside the house, and between the modem and the ISP outside the house, are needed. Furthermore, installing the additional devices and cables, as well as connecting to the Internet using the additional devices, is inconvenient.

### SUMMARY OF THE INVENTION

Accordingly, it is an aspect of the present invention to provide a method and a system for connecting a refrigerator, through a simple wireless connection, to an outdoor network environment, for example, the Internet, without installing additional network devices inside the house.

Additional aspects of the present invention will be set forth in part in the description which follows and, in part, will be obvious from the description, or may be learned by practice of the invention.

According to an aspect of the present invention, a method for connecting a refrigerator to the Internet is provided. The refrigerator includes a predetermined function key for Internet connection, a wireless interface unit for wireless connection to the Internet according to manipulation by the function key, and a display unit displaying thereon a web page by a built-in web browser when the refrigerator is connected to the Internet through the wireless interface unit. The method comprises processing manipulation of the predetermined function key for Internet connection by a user, and executing the web browser to be displayed on the display unit based on the manipulation; establishing a wireless connection between the wireless interface unit and an outdoor wireless Internet AP provided outdoors, when the web browser is executed; and connecting the refrigerator to the Internet through the wireless connection and a wireless ISP associated with the outdoor wireless Internet AP.

According to another aspect of the present invention, the method further comprises performing an authentication procedure through a predetermined screen for authentication displayed on the display unit, as the wireless connection is established; and connecting the refrigerator to the Internet through the wireless connection and the wireless ISP associated with the outdoor wireless Internet AP, if authentication based on the authentication procedure is successful.

According to a further aspect of the present invention, establishing the wireless connection comprises causing the wireless interface unit to call the outdoor wireless Internet AP and determine if the outdoor wireless Internet AP is in a connectable state; and connecting the wireless interface unit of the refrigerator to the outdoor wireless Internet AP, by executing the web browser, if it is determined that the outdoor wireless internet AP is in the connectable state.

According to yet another aspect of the present invention, the method further comprises providing a predetermined message to the user to indicate that the outdoor wireless Internet AP is in the connectable state, if it is determined that the outdoor wireless Internet AP is in the connectable state.

According to still another aspect of the present invention, a system for connecting a refrigerator to the Internet is provided. The refrigerator includes a predetermined function key for Internet connection, a wireless interface unit for wireless connection to the Internet according to manipulation by the function key, and a display unit displaying a web browser thereon by a built-in browser when the refrigerator is connected to the Internet through the wireless interface unit. The system comprises an outdoor wireless Internet AP provided outside the house, and separated from the refrigerator by equal to or less than a predetermined distance, so that the wireless interface unit is wirelessly connected to the outdoor wireless Internet AP when the browser is executed; a wireless ISP associated with the outdoor wireless Internet AP, providing an Internet connection service; and the refrigerator comprising a control unit that executes the web browser so as to display it on the display unit, and connects the wireless interface unit to the Internet according to the Internet connection service provided by the wireless ISP, if a user manipulates the predetermined function key for Internet connection.

According to another aspect of the present invention, the control unit connects the refrigerator to the Internet according to the Internet connection service provided by the wireless ISP, if an authentication process, using a predetermined screen for authentication displayed on the display unit, is successful. The authentication process may be performed as the wireless interface unit is connected to the outdoor wireless Internet AP.

According to yet another aspect of the present invention, the control unit connects the wireless interface unit of the refrigerator to the outdoor wireless Internet AP by executing the web browser, if it is determined that the outdoor wireless Internet AP is in a connectable state, in response to the wireless interface unit calling the outdoor wireless Internet AP so as to determine if the outdoor wireless Internet AP is in the connectable state.

According to still another aspect of the present invention, the refrigerator further comprises a state identifying unit which provides the user with a predetermined message indicating that the outdoor wireless Internet AP is in the connectable state, if it is determined that the outdoor wireless Internet AP is in the connectable state.

### BRIEF DESCRIPTION OF THE DRAWINGS

These and other aspects of the present invention will become apparent and more readily appreciated from the following description of exemplary embodiments of the present invention, taken in conjunction with the accompany drawings of which:

FIG. 1 is a schematic view illustrating an Internet connection system of a refrigerator according to an exemplary embodiment of the present invention;

FIG. 2 is a block diagram illustrating a configuration of the refrigerator according to an exemplary embodiment of the present invention;

FIG. 3 is a control flow chart for Internet connection of the refrigerator according to an exemplary embodiment of the present invention; and

FIG. 4 is a schematic view illustrating an Internet connection system of a conventional refrigerator.

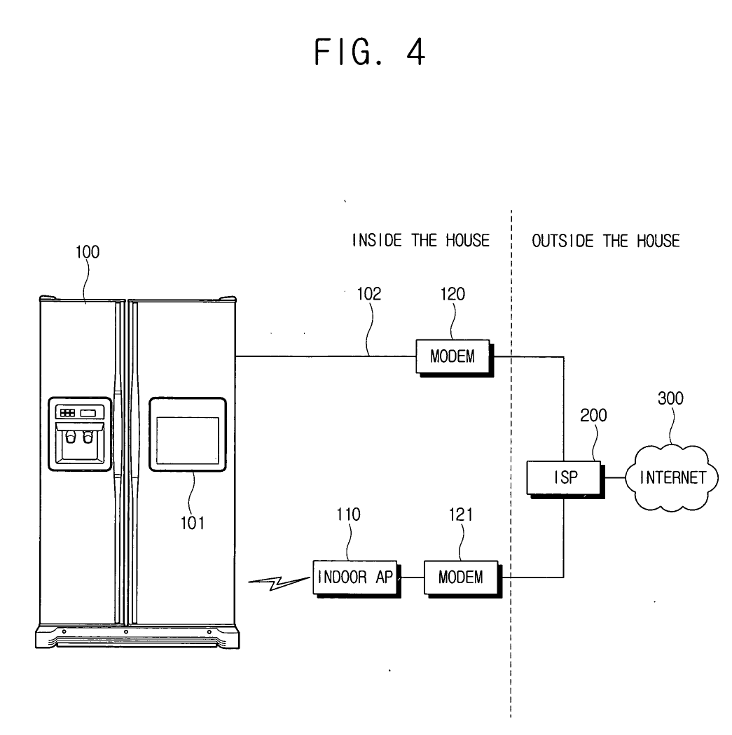

### DETAILED DESCRIPTION OF THE EXEMPLARY EMBODIMENTS OF THE PRESENT INVENTION

Reference will now be made in detail to the exemplary embodiments of the present invention, which are illustrated in the accompanying drawings, wherein like reference numerals refer to like elements throughout. The exemplary embodiments are described below so as to explain the present invention by referring to the figures.

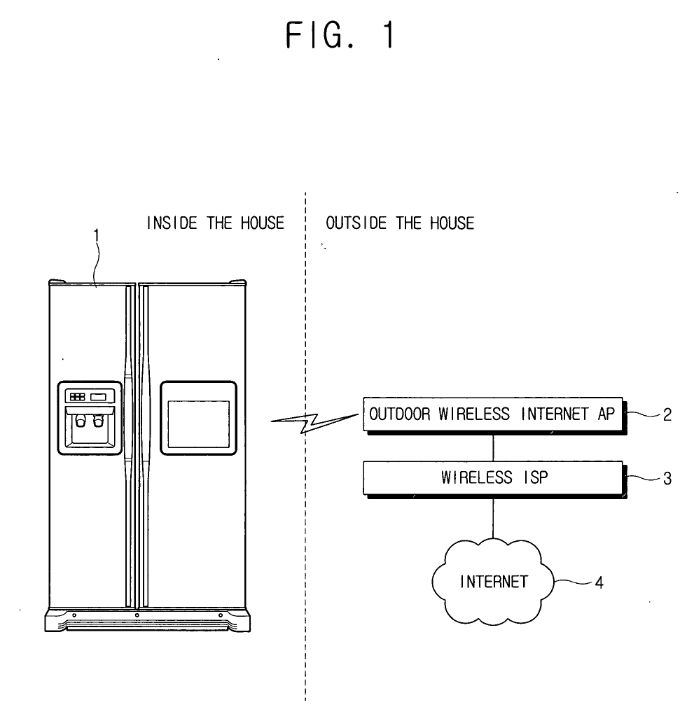

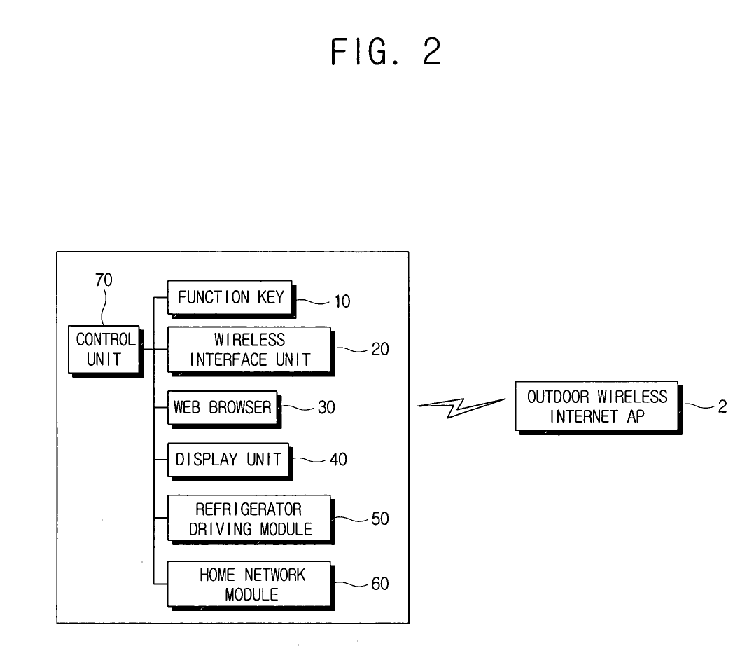

FIG. 1 schematically illustrates an Internet connection system of a refrigerator according to an exemplary embodiment of the present invention. As illustrated, the Internet connection system is constructed with a refrigerator 1 in which a wireless interface unit 20 (see FIG. 2) and a web browser 30 (see FIG. 2) are built, whereby the wireless interface unit 20 in the refrigerator 1 can wirelessly connect to an outdoor wireless Internet AP 2, which is provided outside a house where the refrigerator is located, by a control unit 70 to be described later, and then connect to the Internet 4 by way of a wireless ISP 3.

In this exemplary embodiment, the refrigerator 1 can wirelessly connect to the outdoor wireless Internet AP 2 and then the Internet 4, without having a separate network device, such as an additional indoor AP or a modem, installed inside the house. The outdoor wireless Internet AP 2 can be separated from the refrigerator 1 within a predetermined distance outside the house, on a regional basis, so that it can be wirelessly connected to the wireless interface unit 20 of the refrigerator 1 when a web browser 30 is executed according to a user's manipulation. The wireless ISP 3 is connected to the outdoor wireless Internet AP 2, thereby providing services for connection to the Internet 4.

A configuration of the refrigerator 1 according to this exemplary embodiment of the present invention will be described in more detail with reference to FIG. 2. As illustrated in FIG. 2, the refrigerator 1 comprises a predetermined function key 10 to execute a connection to the Internet 4, a wireless interface unit 20 for wireless connection to the Internet 4 (through the outdoor wireless Internet AP 2) according to manipulation by the function key 10, a display unit 40 displaying thereon web pages by a web browser 30 built in the refrigerator 1 when it is connected to the Internet 4 through the wireless interface unit 20, and a control unit 70 controlling these elements. The refrigerator 1 can be constructed so as to comprise a refrigerator driving module 50 required for performing the proper functions of a refrigerator, and a home network module 60 for constructing home networking in association with other electric home appliances, and to allow them to be controlled by the control unit 70.

The function key 10 may be disposed on one side of the display unit 40 provided in front of a door of the refrigerator 1. The function key 10 may be constructed to comprise predetermined manipulation keys required for driving the refrigerator driving module 50, to thereby perform and control refrigeration and freezing functions of the refrigerator 1. The function key 10 may also be constructed so as to comprise a predetermined manipulation key required for driving a home network module 60, to thereby perform mutual data communication with other electric home appliances for exchanging information. At this time, the function key 10 may be provided as a button-type on one side of the display unit 40, or may be constructed to perform any necessary function by means of a separate remote control. Functions of the function key 10 may also be performed by allowing any necessary function to be selected by means of a predetermined function icon provided in a predetermined menu displayed on the display unit 40. Additionally, the function key 10 may be constructed as a touch screen-type input means provided on the display unit 40 so that it can be manipulated according to a predetermined menu.

The wireless interface unit 20 refers to a device for wireless communication with the outdoor wireless Internet AP 2 provided outdoors so as to connect to the Internet 4, according to manipulation by the function key 10. The wireless interface unit 20 may be constructed, for example, with a wireless LAN card. The wireless interface unit 20 receives a wireless LAN signal from and transmits a wireless LAN signal to the outdoor wireless Internet AP 2. For example, according to the IEEE 802.11b Wireless LAN Specification, the wireless interface unit 20 can be constructed so that it can be wirelessly connected to a network, such as the Internet, at a transmission speed of 11 Mbps or more. At this time, the outdoor wireless Internet AP 2, provided outside the house may be interconnected with the wireless ISP 3 by way of a connection port (not shown). The wireless interface unit 20 may be provided on one side of the refrigerator 1, or built in the display unit 40 so that both of the wireless interface unit 20 and the display unit 40 can be installed in front of the refrigerator door.

Generally, the display unit 40 is installed in front of the refrigerator door, but the installation place thereof may vary appropriately as needed. The display unit 40 may display thereon a variety of information required for performing and controlling various functions of the refrigerator 1. In this connection, the display unit 40 may be constructed so as to comprise a variety of display panels such as a liquid crystal display (LCD), a plasma display panel (PDP), an organic light-emitting diode (OLED), etc., and a panel driving unit for driving the display panel. The display unit 40 provides a screen in the form of a graphic user interface by means of various display panels, and may display an operation state of the refrigerator or a connection state of the refrigerator to the Internet. To display the operation state or the connection state, a separate visual state identifying unit such as a light-emitting diode (LED) or an aural state identifying unit such as a speaker may be included in the display unit 40.

Accordingly, when a user selects execution of Internet connection through manipulation by the predetermined function key 10, the control unit 70 senses it and causes the built-in web browser 30 to be displayed on the display unit 40. The web browser 30 may be constructed so as to be stored in a separate storage unit provided within the display unit 40, wherein the storage unit may be embodied with the use of various electronic storage devices. When the wireless interface unit 20 is connected to the outdoor wireless Internet AP 2 and to the Internet 4 by way of the wireless ISP 3, a predetermined web page is displayed through the display unit 40 by the built-in web browser 30.

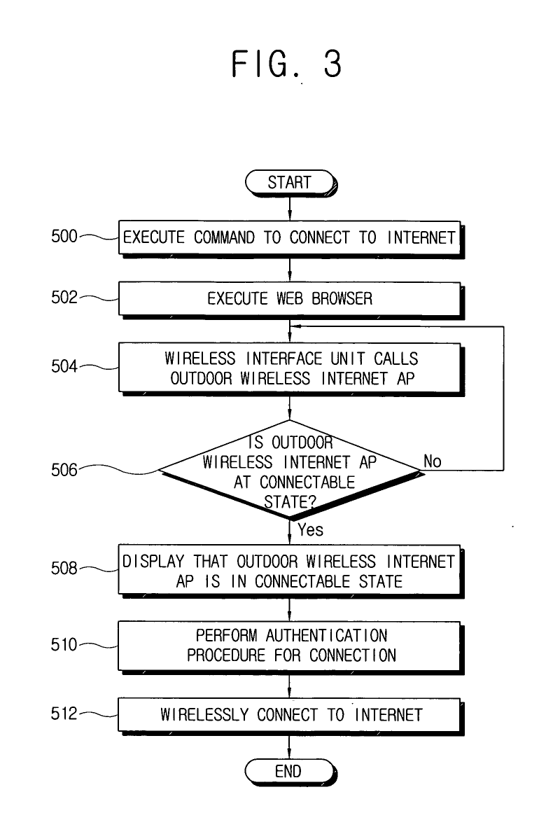

A process for wireless connection to the Internet 4 by means of a refrigerator 1 according to an exemplary embodiment of the present invention will be described with reference to FIG. 3.

A user manipulates a predetermined function key 10 provided on one side of a display unit 40 in front of the refrigerator 1 and executes a command to connect to the Internet at operation 500. A key signal according to the manipulation of the predetermined function key 10 is supplied to a control unit 70, and the control unit 70 executes a built-in web browser 30 stored in a predetermined storage unit so that it is displayed through the display unit 40 at operation 502. At approximately the same time as the command to connect to the Internet is executed and the web browser 30 is displayed, the control unit 70 controls the wireless interface unit 20 so that it calls an outdoor wireless Internet AP 2 to receive a wireless LAN signal at operation 504.

Alternatively, according to the command to connect to the Internet, the wireless interface unit 20 may first call the outdoor wireless Internet AP 2 and receive the wireless LAN signal, and then, the web browser 30 may be executed and displayed through the display unit 40.

Here, the outdoor wireless Internet AP 2 is installed at a predetermined location, thereby maintaining an appropriate separate distance outside a house where the refrigerator 1 is located, and may be supplied, for example, from a separate commercial service entity. When the user is registered as a subscriber of the commercial service entity, which supplies the outdoor wireless Internet AP 2, the user may pass through a predetermined procedure for authentication so as to connect to the Internet 4 wirelessly through the outdoor wireless Internet AP 2. The outdoor wireless Internet AP 2 is provided so as to supply a service wirelessly connectable to the Internet 4 to the user within range of the wireless Internet AP 2.

When the wireless interface unit 20 is connected to the outdoor wireless Internet AP 2, a predetermined screen for authentication is displayed on the display unit 40, and then an authentication procedure for Internet connection based on a user ID and a password is performed at operation 510. If the user authentication is successfully completed through the above authentication procedure, the user can connect to the Internet 4 wirelessly through the wireless ISP 3 associated with the outdoor wireless Internet AP 2 at operation 512 and then use an Internet service as desired.

Prior to performing an authentication procedure to connect to the outdoor wireless Internet AP 2, the control unit 70 can determine whether the wireless interface unit 20 of the refrigerator 1 is in a state of being connectable to the outdoor wireless Internet AP 2 at operation 506. If the outdoor wireless Internet AP 2 is in the connectable state, the control unit 70 may indicate, through the display unit 40 or a separate state identifying unit, that the outdoor wireless Internet AP 2 is in the connectable state at operation 508. To inform the user that the outdoor wireless Internet AP 2 is in the connectable state, the state identifying unit may indicate this information as a visual or aural message, as described above. If the outdoor wireless Internet AP 2 is not in the connectable state, the control unit 70 maintains a stand-by state until the wireless interface unit 20 becomes connectable to the outdoor wireless Internet AP 2.

As described above, according to the exemplary embodiments of the present invention, there is no need to install additional network connection devices, except for the refrigerator 1 in which the wireless interface unit 20 is installed, inside the house. Accordingly, a space for installing additional devices inside the house is not needed, and work required to connect the Internet by way of the additional devices is avoided. Additionally, the refrigerator according to the exemplary embodiments of the present invention can wirelessly connect to the Internet in a simple manner, and can also participate in networking for information sharing and data communication by means of other electric home appliances associated with the refrigerator.

Even if a user has to re-install the refrigerator 1 because the user moves to a new residence, wireless connection to the Internet 4 remains simple by way of a wireless ISP 3 associated with an outdoor wireless Internet AP 2 installed outside the new residence of the refrigerator 1, according to the exemplary embodiments of the present invention.

Furthermore, by employing a method for Internet connection by a refrigerator according to the exemplary embodiments of the present invention, wireless connection to an external network environment, such as the Internet, is simple, without having additional network devices installed inside the house. Even if a user moves to a new residence, wireless connection to the Internet is convenient by means of the refrigerator, owing to a network environment constructed in the new residence, without any need to install separate devices for a network connection inside the house.

Although various exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A method for connecting a refrigerator to the Internet, said refrigerator having a function key which initiates connection to the Internet, a wireless interface unit for wireless connection to the Internet according to manipulation by the function key, and a display unit which displays a web page by a browser if the refrigerator is connected to the Internet through the wireless interface unit, the method comprising:
manipulating the function key to initiate connection to the Internet and executing the web browser to be displayed on the display unit;
wirelessly connecting the wireless interface unit to an outdoor wireless Internet access point (AP) provided outside a building where the refrigerator is located, if the web browser is executed; and
wirelessly connecting the refrigerator to the Internet through a wireless Internet service provider associated with the outdoor wireless Internet AP, if the wireless interface unit is wirelessly connected to the outdoor wireless Internet AP.

2. The method according to claim 1, further comprising performing authentication through a predetermined screen displayed on the display unit, if the wireless interface unit is wirelessly connected to the outdoor wireless Internet access point (AP),
wherein the wireless connection of the refrigerator to the Internet through the wireless Internet service provider associated with the outdoor wireless Internet AP is performed only if the authentication is successful.

3. The method according to claim 2, wherein the wireless connection of the wireless interface unit to the outdoor wireless Internet access point (AP) comprises controlling the wireless interface unit to call the outdoor wireless Internet AP and determine if the outdoor wireless Internet AP is in a connectable state,
wherein the wireless connection of the wireless interface unit to the outdoor wireless Internet AP is performed only if it is determined that the outdoor wireless internet AP is in the connectable state.

4. The method according to claim 3, further comprising providing a message indicating that the outdoor wireless Internet access point (AP) is in the connectable state, if it is determined that the outdoor wireless Internet AP is in the connectable state.

5. The method according to claim 4, wherein the message is one of a visual message and an aural message.

6. The method according to claim 1, wherein the wireless connection of the wireless interface unit to the outdoor wireless Internet access point (AP) comprises controlling the wireless interface unit to call the outdoor wireless Internet AP and determine if the outdoor wireless Internet AP is in a connectable state,
wherein the wireless connection of the wireless interface unit to the outdoor wireless Internet AP is performed only if it is determined that the outdoor wireless internet AP is in the connectable state.

7. The method according to claim 6, further comprising providing a message indicating that the outdoor wireless Internet access point (AP) is in the connectable state, if it is determined that the outdoor wireless Internet AP is in the connectable state.

8. The method according to claim 7, wherein the message is one of a visual message and an aural message.

9. A system for connecting a refrigerator to the Internet, said refrigerator having a function key which initiates connection to the Internet, a wireless interface unit for wireless connection to the Internet according to manipulation by the function key, and a display unit which displays a web page by a web browser if the refrigerator is connected to the Internet through the wireless interface unit, the system comprising:
an outdoor wireless Internet access point (AP), provided outside a building where the refrigerator is located and separated from the refrigerator by a predetermined distance, which wirelessly connects to the wireless interface unit if the web browser is executed;
a wireless Internet service provider (ISP) associated with the outdoor wireless Internet AP, which provides an Internet connection service; and
a control unit in the refrigerator which executes the web browser to display the web page on the display unit, and controls the wireless interface unit to be wirelessly connected to the Internet according to the Internet connection service provided by the wireless ISP, if the function key is manipulated to initiate connection to the Internet.

10. The system according to claim 9, wherein the control unit controls the wireless connection of the wireless interface unit to the Internet, according to the Internet connection service provided by the wireless Internet service provider, only if authentication performed through a predetermined screen displayed on the display unit is successful.

11. The system according to claim 10, wherein the control unit controls the wireless interface unit to call the outdoor wireless Internet access point (AP) to determine if the outdoor wireless Internet AP is in a connectable state, and controls the wireless connection of the wireless interface unit to the outdoor wireless Internet AP only if it is determined that the outdoor wireless Internet AP is in the connectable state.

12. The system according to claim 11, wherein the refrigerator further comprises a state identifying unit which provides a message indicating that the outdoor wireless Internet access point (AP) is in the connectable state, if it is determined that the outdoor wireless Internet AP is in the connectable state.

13. The system according to claim 12, wherein the state identifying unit is the display unit.

14. The system according to claim 12, wherein the message is one of a visual message and an aural message.

15. The system according to claim 9, wherein the control unit controls the wireless interface unit to call the outdoor wireless Internet access point (AP) to determine if the outdoor wireless Internet AP is in a connectable state, and controls the wireless connection of the wireless interface unit to the outdoor wireless Internet AP only if it is determined that the outdoor wireless Internet AP is in the connectable state.

16. The system according to claim 15, wherein the refrigerator further comprises a state identifying unit which provides a message indicating that the outdoor wireless Internet access point (AP) is in the connectable state, if it is determined that the outdoor wireless Internet AP is in the connectable state.

17. The system according to claim 16, wherein the state identifying unit is the display unit.

18. The system according to claim 16, wherein the message is one of a visual message and an aural message.
